(19) United States
(12) Patent Application Publication
(10) Pub. No.: US 2020/0085238 A1
(43) Pub. Date: Mar. 19, 2020

(54) METHODS OF OPERATING A COOKING APPLIANCE IN COORDINATED COMMUNICATION ACROSS MULTIPLE DEVICES

(71) Applicant: Haier US Appliance Solutions, Inc., Wilmington, DE (US)

(72) Inventors: Jeff Donald Drake, Louisville, KY (US); Nelson Tanquero, Louisville, KY (US); William Wesley Bornor, Plymouth, MI (US); Irena J. McDowell, Louisville, KY (US); Jared Joseph Hatfield, Louisville, KY (US); Chad Michael Helms, Louisville, KY (US)

(21) Appl. No.: 16/135,499

(22) Filed: Sep. 19, 2018

(51) Int. Cl. A47J 36/32; A23L 5/10; H04L 29/08

(52) U.S. Cl. CPC A47J 36/321; F27D 2021/026; H04L 67/125; A23L 5/15

(57) ABSTRACT

A method of operating a cooking appliance in coordinated communication with, for example, a remote server and a user device, is provided. The method may include receiving a recipe selection signal of a predetermined recipe at the remote server, and transmitting a recipe information signal to the cooking appliance based on the predetermined recipe. The method may further include receiving an appliance confirmation signal from the cooking appliance in response to a discrete recipe action of the predetermined recipe being performed at the cooking appliance subsequent to receiving the recipe selection signal. The method may still further include transmitting a determined status signal to the user device based on the received appliance confirmation signal.

### FIELD OF THE INVENTION

The present subject matter relates generally to systems and methods for aiding cooking operations, and more particularly to systems and methods for coordinating information and operations across multiple devices.

### BACKGROUND OF THE INVENTION

Recipes or prepared instructions for cooking a specific food item have been a long-standing staple of cooking. Although some individuals are able to cook free of any prepared list of steps, many individuals require a specific set of instructions in order to cook or prepare a desired food item. These recipes may be provided in books, cards, and increasingly, on an electronic user device. A website or software application (i.e., “app”) may present a recipe as a dynamic or animated set of instructions, which many users find easier to understand than a generic printed or text-based recipe.

Cooking appliances, such as ovens, ranges, and cooktops, are often a critical tool for following a recipe. Cooking appliances typically include one or more heating elements that are controlled by a user interface mounted to the corresponding cooking appliance. The user interface often includes one or more control inputs, such as knobs and buttons, as well as a display for presenting information relevant to cooking operations, such as the temperature at corresponding heating element. A user is typically required to directly press or engage the control inputs in order to control operation of the cooking appliance. If a user is following recipe, the user must often read how the cooking appliance is to be used (e.g., the temperature at which it must be set), and then manually direct the cooking appliance accordingly. This may be true regardless of whether the recipe is provided in a book, on an electronic user device, or elsewhere.

Recently, interest has been increasing in the development of remote operation of home appliances. Some cooking appliances and even been configured so that they may be controlled remotely on a user's smartphone or computer. However, difficulties may still arise if a recipe is being followed or if the user wishes to alternately control some operations at the cooking appliance and some operations remotely. For instance, may be difficult for user to know what steps of the recipe have been performed already and how to coordinate that information between multiple devices.

As a result, there is a need for improved systems and methods for performing cooking operations. In particular, would be advantageous to provide systems and methods for coordinated communication between a cooking appliance and other devices.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating a cooking appliance in coordinated communication with a remote server and a user device is provided. The method may include receiving a recipe selection signal of a predetermined recipe at the remote server, and transmitting a recipe information signal to the cooking appliance based on the predetermined recipe. The method may further include receiving an appliance confirmation signal from the cooking appliance in response to a discrete recipe action of the predetermined recipe being performed at the cooking appliance subsequent to receiving the recipe selection signal. The method may still further include transmitting a determined status signal to the user device based on the received appliance confirmation signal.

In another exemplary aspect of the present disclosure, a method of operating a cooking appliance in coordinated communication with a remote server and a user device is provided. The method may include receiving a recipe selection signal of a predetermined recipe at the remote server, and transmitting a recipe information signal to the cooking appliance based on the predetermined recipe. The method may also include initiating activation of a heating element based on the predetermined recipe for a discrete recipe action of the predetermined recipe subsequent to receiving the recipe selection signal. The method may further include receiving an appliance confirmation signal in response to initiating activation of the heating element, and transmitting a determined status signal to the user device based on the received appliance confirmation signal.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a system according to exemplary embodiments of the present disclosure.

FIG. 2 provides a side schematic view of the exemplary system of FIG. 1.

FIG. 3 provides a schematic view of a system for engaging a cooking appliance according to exemplary embodiments of the present disclosure.

FIG. 4 provides a flow chart illustrating a method of operating a system according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

Generally, the present disclosure provides methods and systems for coordinating and alternately controlling a cooking appliance from a user device, a remote server, or the cooking appliance itself.

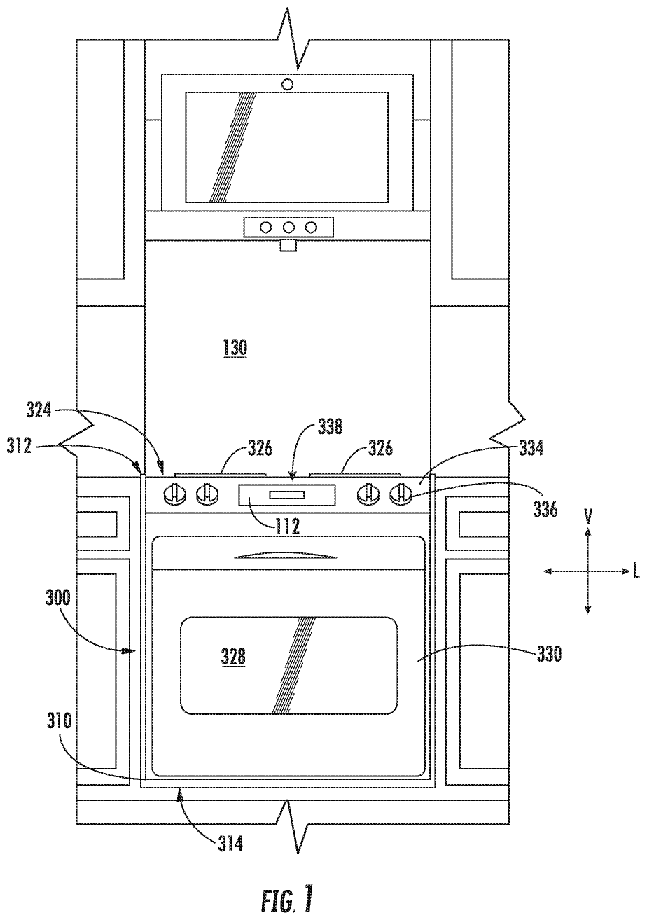

Turning now to the figures, FIGS. 1 through 3 provide various views of a system for coordinating and controlling a cooking appliance 300, such as a cooktop appliance, according to exemplary embodiments of the present disclosure. Along with cooking appliance 300, system generally includes a remote server 404 and one or more user devices 408, as will be further described below.

As shown cooking appliance 300 defines a vertical direction V, a lateral direction L, and a transverse direction T, for example, at a cabinet 310. The vertical, lateral, and transverse directions are mutually perpendicular and form an orthogonal direction system. As shown, cooking appliance 300 extends along the vertical direction V between a top portion 312 and a bottom portion 314; along the lateral direction L between a left side portion and a right side portion; and along the traverse direction T between a front portion and a rear portion.

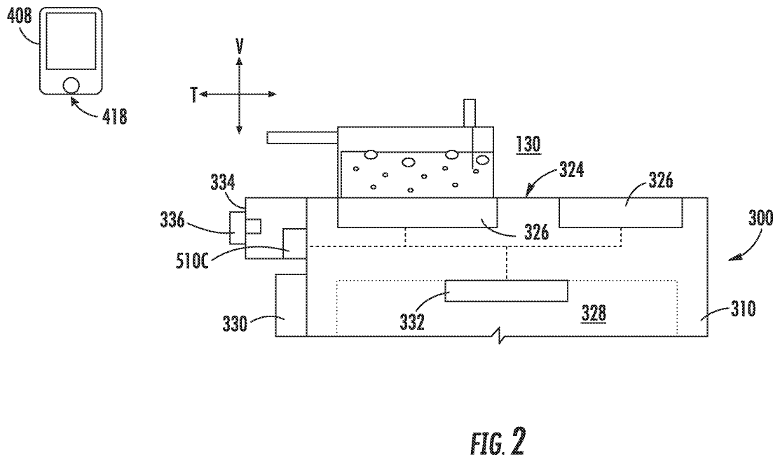

Cooking appliance 300 can include a chassis or cabinet 310 and a cooktop surface 324 having one or more heating elements 326 for use in, for example, heating or cooking operations. In one example embodiment, cooktop surface 324 is constructed with ceramic glass. In other embodiments, however, cooktop surface 324 may include of another suitable material, such as a metallic material (e.g., steel) or another suitable non-metallic material. Heating elements 326 may be various sizes and may employ any suitable method for heating or cooking an object, such as a cooking utensil, and its contents. In one embodiment, for example, heating element 326 uses a heat transfer method, such as electric coils or gas burners, to heat the cooking utensil. In another embodiment, however, heating element 326 uses an induction heating method to heat the cooking utensil directly. In turn, heating element 326 may include a gas burner element, resistive heat element, radiant heat element, induction element, or another suitable heating element. Moreover, when the cooking appliance 300 is illustrated as having a cooktop surface 324 in FIGS. 1 and 2, it is understood that alternative embodiments may be provided without a cooktop.

In some embodiments, cooking appliance 300 includes an insulated cabinet 310 that defines a cooking chamber 328 selectively covered by a door 330. One or more heating elements 332 (e.g., top broiling elements or bottom baking elements) may be enclosed within cabinet 310 to heat cooking chamber 328. Heating elements 332 within cooking chamber 328 may be provided as any suitable element for cooking the contents of cooking chamber 328, such as an electric resistive heating element, a gas burner, microwave element, halogen element, etc. Thus, cooking appliance 300 may be referred to as an oven range appliance. As will be understood by those skilled in the art, cooking appliance 300 is provided by way of example only, and the present subject matter may be used in any suitable cooking appliance 300, such as a double oven range appliance or a standalone cooktop (e.g., fitted integrally with a surface of a kitchen counter). Thus, the example embodiments illustrated in the figures are not intended to limit the present subject matter to any particular cooking chamber or heating element configuration, except as otherwise indicated.

As illustrated, a user interface or interface panel 334 may be provided on cooking appliance 300. Although shown at front portion of cooking appliance 300, another suitable location or structure (e.g., a backsplash) for supporting user interface panel 334 may be provided in alternative embodiments. In some embodiments, user interface panel 334 includes input components or controls 336, such as one or more of a variety of electrical, mechanical, or electro-mechanical input devices. Controls 336 may include, for example, rotary dials, knobs, push buttons, and touch pads. A controller 510C is in communication with user interface panel 334 and controls 336 through which a user may select various operational features and modes and monitor progress of cooking appliance 300. In additional or alternative embodiments, user interface panel 334 includes a display component 338, such as a digital or analog display in communication with a controller 510C and configured to provide operational feedback to a user. In certain embodiments, user interface panel 334 represents a general purpose I/O (“GPIO”) device or functional block.

Generally, controller 510C can be positioned in any suitable location throughout cooking appliance 300. For example, controller 510C may be located proximate user interface panel 334 toward front portion of cooking appliance 300.

As shown, controller 510C is communicatively coupled (i.e., in operative communication) with user interface panel 334, including controls 336 and display component 338. Controller 510C may also be communicatively coupled with various operational components of cooking appliance 300, such as heating elements (e.g., 326, 332), sensors, etc. Input/output (“I/O”) signals may be routed between controller 510C and the various operational components of cooking appliance 300. Thus, controller 510C can selectively activate and operate these various components. Various components of cooking appliance 300 are communicatively coupled with controller 510C via one or more communication lines such as, for example, conductive signal lines, shared communication busses, or wireless communications bands.

In some embodiments, an image monitor 112 is provided at or adjacent to cooking appliance 300 (e.g., at or as part of display component 338). For instance, image monitor 112 may be mounted to cabinet 310 (e.g., above cooking chamber 328). Generally, image monitor 112 may be any suitable type of mechanism for visually presenting a digital (e.g., interactive or animated) image. For example, image monitor 112 may be a liquid crystal display (LCD), a plasma display panel (PDP), a cathode ray tube (CRT) display, etc. Thus, image monitor 112 includes an imaging surface (e.g., screen or display panel) at which the digital image is presented or displayed as an optically-viewable picture (e.g., static image or dynamic video) to a user.

The optically-viewable picture may correspond to any suitable signal or data received or stored by cooking appliance 300 (e.g., at controller 510C). As an example, image monitor 112 may present recipe information in the form of viewable text or images. As another example, image monitor 112 may present a remotely captured image, such as a live (e.g., real-time) dynamic video stream received from a separate user or device. As yet another example, image monitor 112 may present a graphical user interface (GUI) that allows a user to select or manipulate various operational features of cooking appliance 300 or system. During use of such GUI embodiments, a user may engage, select, or adjust the image presented at image monitor 112 through any suitable input, such as controls 336, a voice-command microphone, associated touch panels (e.g., capacitance or resistance touch panel) or sensors overlaid across the imaging surface, etc.

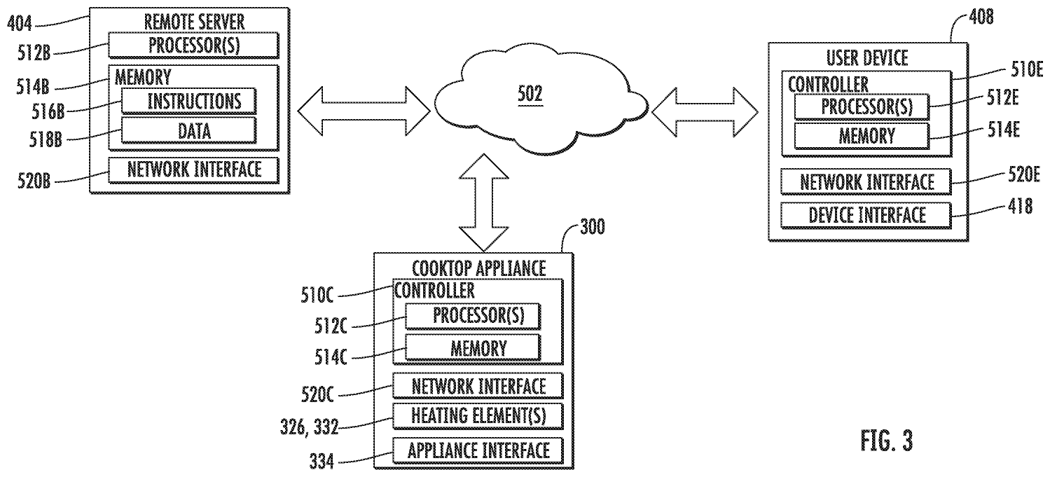

Turning especially to FIG. 3, a schematic view is provided of system, illustrating cooking appliance 300, one or more remote servers 404, and one or more user devices 408. As shown, cooking appliance 300 can be communicatively coupled with a network 502 and various other nodes, such as a remote server 404 and a user device 408.

In some embodiments, controller 510C includes one or more memory devices 514C and one or more processors 512C. The processors 512C can be any suitable processing device (e.g., a processor core, a microprocessor, an ASIC, a FPGA, a microcontroller, etc.) and can be one processor or a plurality of processors that are operatively connected and can execute programming instructions or control code associated with operation of cooking appliance 300. The memory devices 514C (i.e., memory) can include one or more non-transitory computer-readable storage mediums, such as RAM, ROM, EEPROM, EPROM, flash memory device, magnetic disks, etc., and combinations thereof. The memory devices 514C can store data and instructions that are executed by the processor 512C to cause cooking appliance 300 to perform operations. In one embodiment, the processor 512C executes programming instructions stored in memory 514C. The memory 514C may be a separate component from the processor 512C or may be included onboard within the processor 512C.

Controller 510C includes a network interface 520C such that controller 510C can connect to and communicate over one or more networks (e.g., network 502) with one or more network nodes. Controller 510C can also include one or more transmitting, receiving, or transceiving components for transmitting/receiving communications with other devices communicatively coupled with cooking appliance 300. Additionally or alternatively, one or more transmitting, receiving, or transceiving components can be located off board controller 510C.

Network 502 can be any suitable type of network, such as a local area network (e.g., intranet), wide area network (e.g., internet), low power wireless networks [e.g., Bluetooth Low Energy (BLE)], or some combination thereof and can include any number of wired or wireless links. In general, communication over network 502 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

In some embodiments, a remote server 404, such as a web server, is in operative communication with cooking appliance 300. The server 404 can be used to host an information database (e.g., recipe database, historical appliance use database, etc.). The server can be implemented using any suitable computing device(s). The server 404 may include one or more processors 512B and one or more memory devices 514B (i.e., memory). The one or more processors 512B can be any suitable processing device (e.g., a processor core, a microprocessor, an ASIC, a FPGA, a microcontroller, etc.) and can be one processor or a plurality of processors that are operatively connected. The memory device 512B can include one or more non-transitory computer-readable storage mediums, such as RAM, ROM, EEPROM, EPROM, flash memory devices, magnetic disks, etc., and combinations thereof. The memory devices 514B can store data 518B and instructions 516B which are executed by the processor 512B to cause remote server 404 to perform operations. For example, instructions 516B could be instructions for receiving/transmitting images or image signals, transmitting/receiving recipe signals, etc.

The memory devices 514B may also include data 518B, such as recipe data, image data, video data, historical use data, etc., that can be retrieved, manipulated, created, or stored by processor 512B. The data 518B can be stored in one or more databases. The one or more databases can be connected to remote server 404 by a high bandwidth LAN or WAN, or can also be connected to remote server 404 through network 502. The one or more databases can be split up so that they are located in multiple locales.

Remote server 404 includes a network interface 520B such that remote server 404 can connect to and communicate over one or more networks (e.g., network 502) with one or more network nodes. Network interface 520B can be an onboard component or it can be a separate, off board component. In turn, remote server 404 can exchange data with one or more nodes over the network 502. In particular, remote server 404 can exchange data with cooking appliance 300 or user device 408. Although not pictured, it is understood that remote server 404 may further exchange data with any number of client devices over the network 502. The client devices can be any suitable type of computing device, such as a general purpose computer, special purpose computer, laptop, desktop, integrated circuit, mobile device, smartphone, tablet, or other suitable computing device.

In certain embodiments, a user device 408 is communicatively coupled with network 502 such that user device 408 can communicate with cooking appliance 300. For instance, user device 408 can communicate directly with cooking appliance 300 via network 502. Alternatively, a user can communicate indirectly with cooking appliance 300 by communicating via network 502 with remote server 404 (e.g., directly or indirectly through one or more intermediate remote servers), which in turn communicates with cooking appliance 300 via network 502. Moreover, a user can be in operative communication with user device 408 such that the user can communicate with cooking appliance 300 via user device 408.

User device 408 can be any type of device, such as, for example, a personal computing device (e.g., laptop or desktop), a mobile computing device (e.g., smartphone or tablet), a gaming console or controller, a wearable computing device, an embedded computing device, a remote, or any other suitable type of user computing device. User device 408 can include one or more user device controllers 510E. Controller 510E can include one or more processors 512E and one or more memory devices 514E. The one or more processors 512E can be any suitable processing device (e.g., a processor core, a microprocessor, an ASIC, a FPGA, a controller, a microcontroller, etc.) and can be one processor or a plurality of processors that are operatively connected. The memory device (i.e., memory) can include one or more non-transitory computer-readable storage mediums, such as RAM, ROM, EEPROM, EPROM, flash memory devices, magnetic disks, etc., and combinations thereof. The memory can store data and instructions which are executed by the processor 512E to cause user device 408 to perform operations. Controller 510E a user device network interface 520E such that user device 408 can connect to and communicate over one or more networks (e.g., network 502) with one or more network nodes. Network interface 520E can be an onboard component of controller 510E or it can be a separate, off board component. Controller 510E can also include one or more transmitting, receiving, or transceiving components for transmitting/receiving communications with other devices communicatively coupled with user device 408. Additionally or alternatively, one or more transmitting, receiving, or transceiving components can be located off board controller 510E.

User device 408 includes a device interface 418 having one or more user inputs such as, for example, buttons, one or more cameras, or a monitor configured to display graphical user interfaces or other visual representations to user. For example, the device interface 418 can include a display that can present or display graphical user interfaces corresponding to operational features of cooking appliance 300 such that user may manipulate or select the features to operate cooking appliance 300. The display of user device 408 can be a touch sensitive component (e.g., a touch-sensitive display screen or a touch pad) that is sensitive to the touch of a user input object (e.g., a finger or a stylus). For example, a user may touch the display with his or her finger and type in a series of numbers on the display. In addition, motion of the user input object relative to the display can enable user to provide input to user device 408. User device 408 may provide other suitable methods for providing input to user device 408 as well. Moreover, user device 408 can include one or more speakers, one or more cameras, or more than one microphones such that user device 408 is configured with voice control, motion detection, and other functionality.

Generally, a user may be in operative communication with cooking appliance 300 or one or more user devices 408. For instance, a user may wish to alternately operate cooking appliance 300 directly (e.g., through inputs 336) or remotely (e.g., through user device 408). In particular, a user may wish to control operational features that include activating portions of cooking appliance 300, selecting a temperature or heat setting for cooking appliance 300, or choosing a recipe to be performed, at least in part by the cooking appliance 300.

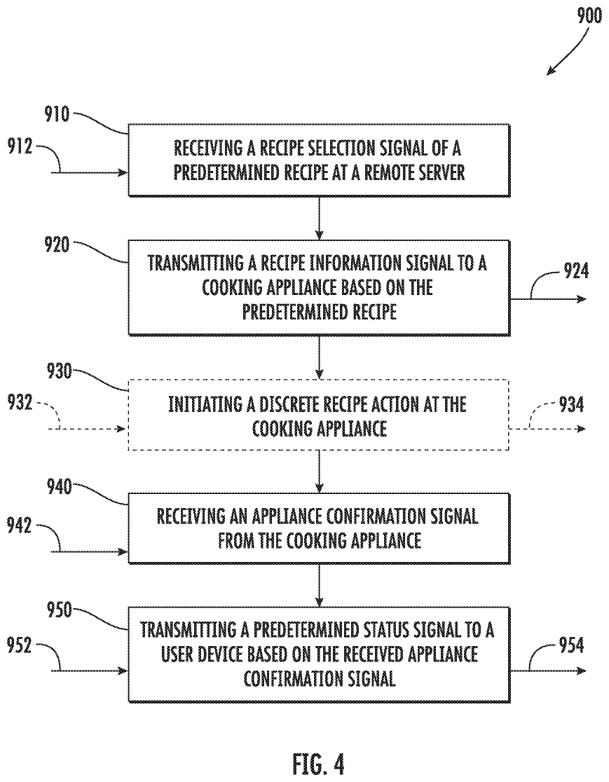

Referring now to FIG. 4, various methods may be provided for use with system in accordance with the present disclosure. In general, the various steps of methods as disclosed herein may, in exemplary embodiments, be performed by the remote server 404 (e.g., at processor 512B) as part of an operation that the remote server is configured to initiate or direct (e.g., a coordinated cooking operation). During such methods, remote server 404 may receive inputs and transmit outputs from various other components of the system. For example, remote server 404 may send signals to and receive signals from cooking appliance 300 or user device 408. In particular, the present disclosure is further directed to methods, as indicated by 900, for operating system. Such methods advantageously facilitate the coordinated and alternated viewing of media (e.g., static images, dynamic video, audio, recipe text, etc.) at cooking appliance 300 or user device 408 and directing operations of one or more appliances. Communication between cooking appliance 300 and user device 408 may be improved. For instance, redundant or incomplete data transmission may be prevented. In certain embodiments, such methods may advantageously facilitate or provide an improved user interface. Additionally or alternatively, such methods may advantageously facilitate guided cooking steps (e.g., from a recipe).

In certain embodiments, cooking appliance 300 is in operative communication with user device 408 via network 502. In turn, controller 510C of cooking appliance 300 may exchange signals with user device 408. Optionally, one or more portions of cooking appliance 300 may be controlled according to signals received from user device 408 (e.g., through one or more intermediate remote servers, remote sensor 404, or both) For instance, one or more heating elements 326, 332 of cooking appliance 300 may be activated or directed to a specific heat output (e.g., in units of British Thermal Units or temperature) based on one or more recipe signals received from remote server 404. Additionally or alternatively, a user may begin viewing a particular recipe at user device 408, continue viewing the same recipe at cooking appliance 300, and return to viewing the same recipe at user device 408. A user's progress through the recipe may be monitored and communicated in real-time to both cooking appliance 300 and user device 408.

Turning now to FIG. 4, at 910, the method 900 includes receiving a recipe selection signal 912 of a predetermined recipe at the remote server. Generally, the recipe selection signal 912 may indicate that the user intends to follow the predetermined recipe in order to cook or create a specific food dish or item. The predetermined recipe may be stored at the remote server or received from an intermediate remote server (e.g., third-party remote server). Moreover, the predetermined recipe may be in the form of text, media (e.g., static images, dynamic video, audio, etc.), hyperlinks, or some combination thereof. For instance, along with text data listing various cooking steps, the predetermined recipe may include videos illustrating specific cooking steps to guide a user in following the predetermined recipe. The recipe selection signal 912 may be received from either the user device or the cooking appliance. Thus, a user may advantageously initiate the method 900 at the user device or the cooking appliance, without having to separately start and manually coordinate the predetermined recipe at both the user device and the cooking appliance.

At 920, the method 900 includes transmitting a recipe information signal 924 to the cooking appliance. The recipe information signal 924 is based on the predetermined recipe and, thus, includes data related to the predetermined recipe that has been selected. The data may include recipe text, media (e.g., static images, dynamic video, audio, etc.), hyperlinks, etc. The data related to the predetermined recipe may be, for instance, presented at the image display of the cooking appliance. In some such embodiments, the data related to the predetermined recipe is presented as discrete cooking steps (e.g., discrete blocks of text, discrete videos, etc.) that are displayed separately from each other. As the user seeks to follow the predetermined recipe, the user may thus toggle through or sequentially follow the cooking steps on the image monitor thereof. Optionally, all of the associated or related information (e.g., all of the data, each cooking step, etc.) for the selected predetermined recipe may be transmitted to the cooking appliance. Advantageously, the information may be locally stored (e.g., temporarily) on the cooking appliance during execution of the predetermined recipe or the method 900, thereby preventing lag without overburdening the storage requirements at the cooking appliance.

In certain embodiments, a user may perform or initiate one or more recipe actions at the cooking appliance in accordance with the predetermined recipe during the method 900. For instance, the predetermined recipe may call for activation of one or more of the heating elements of the cooking appliance (e.g., setting the cooking chamber to a specific temperature, setting a heating element on the cooktop to a specific heat level, etc.). The recipe actions may thus include activation of a heating element on the cooking appliance. Additionally or alternatively, the recipe actions may include selecting or toggling through the cooking steps of the predetermined recipe. If the predetermined recipe and corresponding data on the cooking appliance include a dynamic video illustrating a portion of the predetermined recipe, the recipe actions may include presenting or playing the dynamic video (e.g., on the image monitor of the cooking appliance or on the display of the user device).

In additional or alternative embodiments, one or more recipe actions may be initiated by the system (e.g., through the remote server). At 930, the method 900 optionally includes initiating a discrete recipe action at the cooking appliance. In some such embodiments, a recipe command signal 932 is received at the remote server (e.g., from the user device). The recipe command signal 932 may direct the discrete recipe action and thus indicate that a user has selected the discrete recipe action from the user device. In response to receiving the recipe command signal 932, the remote server may transmit an appliance action signal 934 to the cooking appliance. Upon being received by the cooking appliance, the appliance action signal 934 may cause the cooking appliance to initiate or perform the discrete recipe action (e.g., presenting a dynamic video at the image monitor, activating the heating element of the cooking appliance, or performing any other suitable action relating to the predetermined recipe).

Although discrete recipe actions are described separately as being performed by (a) the user and (b) through the remote server, it is envisioned that certain embodiments may permit either or both options for initiating a discrete recipe action—i.e., performing recipe actions by (a), (b), or both (a) and (b).

At 940, the method 900 includes receiving an appliance confirmation signal 942 from the cooking appliance. Specifically, the appliance confirmation signal 942 may be transmitted, and thereby received, in response to a discrete recipe action being performed at the cooking appliance. For instance, upon beginning or completing the discrete recipe action, the cooking appliance may transmit the appliance confirmation signal 942. The discrete recipe action corresponds to the predetermined recipe, and thus 940 must follow (i.e. be subsequent to) receiving the recipe selection signal 912 at 910.

At 950, the method 900 includes transmitting a determined status signal 954 to the user device based on the received appliance confirmation signal 942. The determined status signal 954 may be a pass-through signal for the appliance confirmation signal 942 received at 940. Alternatively, the determined status signal 954 may be generated at the remote server as part of the method 900. For instance, the remote server may determine the status of the cooking appliance from the appliance confirmation signal 942 and subsequently generate a separate determined status signal 954 that may then be transmitted to the user device at 950. In some embodiments, the determined status signal 954 automatically advances presentation of the predetermined recipe at the user device. Thus, the method 900 may automatically coordinate and indicate that a particular cooking step has been performed, advantageously preventing confusion (e.g., by a user).

The determined status signal 954 transmitted at 950 may be transmitted immediately and without further user input following receipt of the appliance confirmation signal 942 or, alternatively, only after a request is made. For instance, prior to transmitting the determined status signal 954, the remote server may require the user device to transmit a status request signal 952. In other words, optional embodiments may require receiving a status request signal 952 from the user device prior to transmitting the determined status signal 954. Moreover, in some such optional embodiments, the determined status signal 954 is transmitted only in response to receiving the status request signal 952.

In further embodiments, one or more portions of the method 900 may be repeated. For instance, multiple recipe actions may be performed during the method 900. The above-described “discrete recipe action” may thus be a “first recipe action” (e.g., first in time) to be followed by a “second recipe action” (e.g., second in time) subsequent to the first recipe action. In some such embodiments, the method 900 includes receiving a recipe command signal 932 (e.g., from the user device) that corresponds to a second recipe action. Based on the received recipe command signal 932, the remote server may transmit an appliance command signal to initiate the second recipe action at the cooking appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a cooking appliance in coordinated communication with a remote server and a user device spaced apart from the cooking appliance, the cooking appliance comprising a heating element, the method comprising:
receiving a recipe selection signal of a predetermined recipe at the remote server;
transmitting a recipe information signal to the cooking appliance based on the predetermined recipe;
receiving an appliance confirmation signal from the cooking appliance in response to a discrete recipe action of the predetermined recipe being performed at the cooking appliance subsequent to receiving the recipe selection signal; and
transmitting a determined status signal to the user device based on the received appliance confirmation signal.

2. The method of claim 1, wherein the recipe selection signal is received from the user device.

3. The method of claim 1, wherein the recipe selection signal is received from the cooking appliance.

4. The method of claim 1, wherein the discrete recipe action comprises a dynamic video presented at an image monitor of the cooking appliance to illustrate a portion of the predetermined recipe.

5. The method of claim 1, wherein the discrete recipe action comprises activation of the heating element.

6. The method of claim 1, further comprising:
receiving a recipe command signal directing the discrete recipe action; and
initiating the discrete recipe action at the cooking appliance in response to receiving the recipe command signal, wherein the appliance confirmation signal is transmitted in response to initiating the discrete recipe action.

7. The method of claim 1, wherein the determined status signal automatically advances a presentation of the predetermined recipe at the user device.

8. The method of claim 1, further comprising:
receiving a status request signal from the user device prior to transmitting the determined status signal, wherein the determined status signal is transmitted in response to receiving the status request signal.

9. The method of claim 1, wherein the recipe information signal comprises each cooking step of the predetermined recipe for local storage on the cooking appliance.

10. The method of claim 1, wherein the discrete recipe action is a first recipe action, and wherein the method further comprises:
receiving a recipe command signal corresponding to a second recipe action from the user device; and
initiating the second recipe action at the cooking appliance based on the received recipe command signal.

11. A method of operating a cooking appliance in coordinated communication with a remote server and a user device spaced apart from the cooking appliance, the cooking appliance comprising a heating element, the method comprising:
receiving a recipe selection signal of a predetermined recipe at the remote server;
transmitting a recipe information signal to the cooking appliance based on the predetermined recipe;
initiating activation of the heating element based on the predetermined recipe for a discrete recipe action of the predetermined recipe subsequent to receiving the recipe selection signal;
receiving an appliance confirmation signal in response to initiating activation of the heating element; and
transmitting a determined status signal to the user device based on the received appliance confirmation signal.

12. The method of claim 11, wherein the recipe selection signal is received from the user device.

13. The method of claim 11, wherein the recipe selection signal is received from the cooking appliance.

14. The method of claim 11, further comprising:
receiving a recipe command signal directing the discrete recipe action from the user device, wherein initiating activation of the heating element is in response to receiving the recipe command signal.

15. The method of claim 11, wherein the determined status signal automatically advances a presentation of the predetermined recipe at the user device.

16. The method of claim 11, further comprising:
receiving a status request signal from the user device prior to transmitting the determined status signal, wherein the determined status signal is transmitted in response to receiving the status request signal.

17. The method of claim 11, wherein the recipe information signal comprises each cooking step of the predetermined recipe for local storage on the cooking appliance.

18. The method of claim 11, wherein the discrete recipe action is a first recipe action, and wherein the method further comprises:
receiving a recipe command signal corresponding to a second recipe action from the user device; and
initiating the second recipe action at the cooking appliance based on the received recipe command signal.
